(19) United States
(12) Patent Application Publication
(10) Pub. No.: US 2022/0330644 A1
(43) Pub. Date: Oct. 20, 2022

(54) HELMET

(71) Applicant: DYNAMIXYZ, Cesson-Sévigné (FR)

(72) Inventor: Nicolas Stoiber, Rennes (FR)

(21) Appl. No.: 17/723,875

(22) Filed: Apr. 19, 2022

(30) Foreign Application Priority Data
Apr. 19, 2021 (EP) 21305516.3

(51) Int. Cl. A42B 3/04; G02B 27/01; H04N 5/225; G06T 3/40; G06V 40/16; G06V 10/82

(52) U.S. Cl. CPC A42B 3/042; G02B 27/0176; G02B 27/0101; H04N 5/2252; G06T 3/4038; G06V 40/161; G06V 10/82; G02B 2027/0138

(57) ABSTRACT

The invention relates to a head mounted image capture device (1) for capturing facial motion of a user. The device (1) includes a helmet (2) with side portions (5), each for resting on the sides of a user's head. Each side portion (5) includes an arm (6) to which a respective camera (7) is mounted. Each camera (7) is positioned laterally of a user's face for capturing image data relating to a respective side of the user's face.

This application claims priority to European Patent Application No. EP21305516.3, filed on Apr. 19, 2019, which application is herein expressly incorporated by reference, in its entirety.

### FIELD OF THE INVENTION

This invention relates generally to helmets, particularly adaptable helmets. More specifically, although not exclusively, this invention relates to an adaptable helmet for supporting image capture equipment for capturing facial motion of a user.

### BACKGROUND OF THE INVENTION

Facial motion capture is the process of converting the movements of the face of an actor into a digital database using image capture equipment and/or laser scanners. This database may then be used to produce computer graphics, computer animation for movies, games, or real-time avatars. This process results in a more realistic and nuanced computer character animation because the motion of the computer graphic character is derived from the movements of a real person.

A facial motion capture database describes the coordinates of reference points on the actor's face. The capture can be in two or three dimensions. Two-dimensional capture can be achieved using a single camera and capture software. This produces less sophisticated tracking, and is unable to capture fully three-dimensional motions, such as head rotation. Three-dimensional capture is accomplished using multi-camera rigs or laser marker systems. These systems are much more expensive and complicated to use.

EP2340646A1 describes a head-mounted camera system that allows the movements of an actor's face to be captured separately from, but simultaneously with, the movements of the actor's body. Multiple cameras are mounted to a helmet worn by the actor via a pair of rods rotatably mounted to the helmet.

Such known head mounted camera systems often interfere with the performance of the actor, due to the presence of the device in front of the actor's face.

It would therefore be advantageous to provide an adaptable helmet for supporting image capture equipment for capturing facial motion, which mitigates the issues with known systems.

### SUMMARY OF THE INVENTION

The invention provides a head mounted image capture device for capturing facial motion of a user, the device comprising a helmet and a pair of opposed cameras, characterised in that each camera is positioned laterally of a user's face for capturing image data relating to a respective side of the user's face.

Of course, the device according to the invention may comprise more than two cameras and, for example, it may comprise two pairs of cameras, each pair being positioned laterally with respect to a user's face to capture image data relating to a respective side of the user's face.

The device may comprise a central plane, which may segment the lateral sides of the device. The or at least one or each camera may be oriented such that the angle between its image plane and the central plane is less than 45 degrees, for example less than 30 degrees and preferably less than 20 degrees.

The or each camera may be configured to be substantially aligned with the user's nose.

The or each camera may comprise a video camera and/or may be configured to capture digital data representative of one or more images. The device may comprise a memory or memory device, e.g. for recording data captured by the camera(s).

The device may comprise a processor, which may be connected, e.g. operatively connected, to the memory.

The processor may be configured to reconstruct, in use, at least a portion of the user's face, e.g. based on data acquired from at least one camera, preferably both cameras and more preferably only the two cameras. The processor may be configured to reconstruct at least a portion of the user's face using a neural network. The memory may comprise a computer program element stored thereon, which may comprise computer readable program code means for causing the processor to execute a procedure to reconstruct at least a portion of the user's face, e.g. based on data acquired from at least one camera, preferably both cameras and more preferably only the two cameras.

The processor may be configured to assemble or stitch, in use, together image data acquired from at least one camera, preferably both cameras and more preferably only the two cameras, e.g. to reconstruct at least a portion of the user's face. The processor may be configured to assemble or stitch together the image data using a neural network. The memory may comprise a computer program element stored thereon, which may comprise computer readable program code means for causing the processor to execute a procedure to assemble or stitch together image data acquired from at least one camera, preferably both cameras and more preferably only the two cameras, e.g. to reconstruct at least a portion of the user's face.

The processor may be for controlling the operation of the camera(s) and/or the memory. The device may comprise one or more lighting elements or devices, e.g. for illuminating the face of a user. The processor may be operable to control the lighting element(s) or device(s).

The helmet may comprise a front portion, e.g. for resting on the user's forehead. The helmet may comprise a back portion, e.g. for resting on the back of the user's head. The helmet may comprise at least two side portions, e.g. each for resting on the sides of a user's head.

The device may comprise an arm, e.g. to which one of the cameras is mounted. The arm may be mounted to one of the side portions. In some examples, the device may comprise more than one arm, for example an arm mounted and/or connected to each side portion. In some examples, each side portion may comprise an arm to which one of the cameras is mounted.

The device may comprise an articulated structure connecting the front portion to the back portion for approximating the profile of the head of the user.

The articulated structure may comprise at least two members, for example a plurality of members. The members may be connected or linked together, e.g. pivotally, and/or in series. The members may be connected or linked together by fasteners or fixings. The fasteners or fixings may enable the angular position of the members to be adjusted relative to one another.

The device may comprise a cushion. The cushion may extend along at least part of the articulated structure. The cushion may be mounted to one or more or each of the elements, e.g. for supporting the articulated structure on the user's head.

At least one or each element may comprise a cushion support member to which the cushion may be mounted. The or each or at least one of the cushion support members may comprise or may be a cushion support plate.

One end, e.g. a first end, of the cushion may be mounted to the front portion. One end, e.g. a second end, of the cushion may be mounted to the back portion.

The cushion may comprise or contain a flexible substance, such as a foam.

The back portion may comprise a strap or cord. The strap or cord of the back portion may be connected to at least one or each side portion. The strap or cord of the back portion may be elasticated. The back portion may comprise at least one locking slot. The locking slot may be for releasably retaining a portion of the elasticated strap or cord of the back portion, e.g. to enable adjustment of its length.

The device may comprise a top portion, which may be, for example, for resting on top of the user's head. The top portion may comprise a locating means, e.g. for locating the articulated structure relative to the top portion. The locating means may comprise a recess, cutout or receptacle, for example within which the articulated structure is received.

The top portion may comprise a strap or cord. The strap or cord of the top portion may be connected or linked to at least one or each side portion. The strap or cord of the top portion may have an adjustable length. At least one or each end of the strap or cord of the top portion may be secured or securable to one of the side portions.

At least one or each end of the strap or cord of the top portion may be releasably secured to one of the side portions, for example to enable adjustment of its length. The or each end of the strap or cord of the top portion may be releasably secured to one of the side portions by a fastener, e.g. a threaded fastener. The top portion may comprise at least one slot, for example along at least part of its length. The top portion may comprise a slot adjacent the or each of its ends through which the fastener extends, e.g. to enable the length of the strap or cord to be adjusted.

The front portion may comprise a strap or cord. The strap or cord of the front portion may be connected to at least one or each side portion. The strap or cord of the front portion may have an adjustable length. At least one or each end of the strap or cord of the front portion may be secured or securable to one of the side portions.

At least one or each end of the strap or cord of the front portion may be releasably secured to one of the side portions, for example to enable adjustment of its length. The or each end of the strap or cord of the front portion may be releasably secured to one of the side portions by a fastener, e.g. a threaded fastener.

At least one or each arm may be movable, for example rotatable, relative to the side portion. At least one or each side portion and/or at least one or each arm may include at least one visual indicator, e.g. for determining the orientation of the arm.

At least one or each arm may be movable, for example rotatable, relative to the side portion. At least one or each side portion and/or at least one or each arm may include at least one visual indicator, e.g. for determining the orientation of the arm. For the avoidance of doubt, any of the features described herein apply equally to any aspect of the invention.

The invention also provides a computer program element comprising computer readable program code means for causing a processor to execute a procedure to reconstruct, in use, at least a portion of the user's face, e.g. based on data acquired from at least one camera, preferably both cameras and more preferably only the two cameras.

The invention also provides a method, e.g. a computer-implemented method, of reconstructing at least a portion of a user's face, e.g. based on data acquired from at least one camera, preferably two cameras and more preferably only two cameras.

The invention also provides a computer program element comprising computer readable program code means for causing a processor to execute a procedure to assemble or stitch, in use, together image data acquired from at least one camera, preferably both cameras and more preferably only the two cameras, e.g. to reconstruct at least a portion of the user's face.

The invention also provides a method, e.g. a computer-implemented method, of assembling or stitching together image data acquired from at least one camera, preferably two cameras and more preferably only two cameras, e.g. to reconstruct at least a portion of the user's face.

The procedure or method may comprise reconstructing at least a portion of the user's face using a neural network. The procedure or method may comprise assembling or stitching together the image data using a neural network.

The procedure or method may comprise the use of at least one camera positioned laterally of a user's face. The image data captured by the camera(s) may relate to a side, e.g. a respective side, of the user's face.

The reconstructed portion of the user's face may comprise a front portion. The procedure or method may comprise displaying a representation of the front of the user's face. The procedure or method may comprise displaying image data, e.g. as a video, of the representation of the front of the user's face.

The procedure or method may comprise verifying the image data captured, for example using the reconstructed portion of the user's face and/or using the displayed image data.

The invention also provides a computer program element comprising computer readable program code means for causing a processor to execute a procedure to implement one or more steps of the aforementioned method.

The invention also provides the computer program element embodied on a computer readable medium.

The invention also provides a computer readable medium having a program stored thereon, where the program is arranged to make a computer execute a procedure to reconstruct, in use, at least a portion of the user's face, e.g. based on data acquired from at least one camera, preferably both cameras and more preferably only the two cameras.

The invention also provides a computer readable medium having a program stored thereon, where the program is arranged to make a computer execute a procedure to assemble or stitch, in use, together image data acquired from at least one camera, preferably both cameras and more preferably only the two cameras, e.g. to reconstruct at least a portion of the user's face.

The invention also provides a control means or control system or controller comprising the aforementioned computer program element or computer readable medium.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way, unless such features are incompatible.

For the avoidance of doubt, the terms “may”, “and/or”, “e.g.”, “for example” and any similar term as used herein should be interpreted as non-limiting such that any feature so-described need not be present. Indeed, any combination of optional features is expressly envisaged without departing from the scope of the invention, whether or not these are expressly claimed. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Embodiments of the invention will now be described by way of example only with reference to the accompanying drawings in which:

FIG. 1 is a schematic view of a head mounted image capture device according to a first example;

FIG. 2 is a side view of a head mounted image capture device according to a second example;

FIG. 3 is a top view of the device of FIG. 2;

FIG. 4 is a rear view of the device of FIGS. 2 and 3;

FIG. 5 is an upper rear view of the device of FIGS. 2 to 4;

FIG. 6 is a side view similar to that of FIG. 2 with the device mounted on the head of a user.

### DETAILED DESCRIPTION OF THE INVENTION

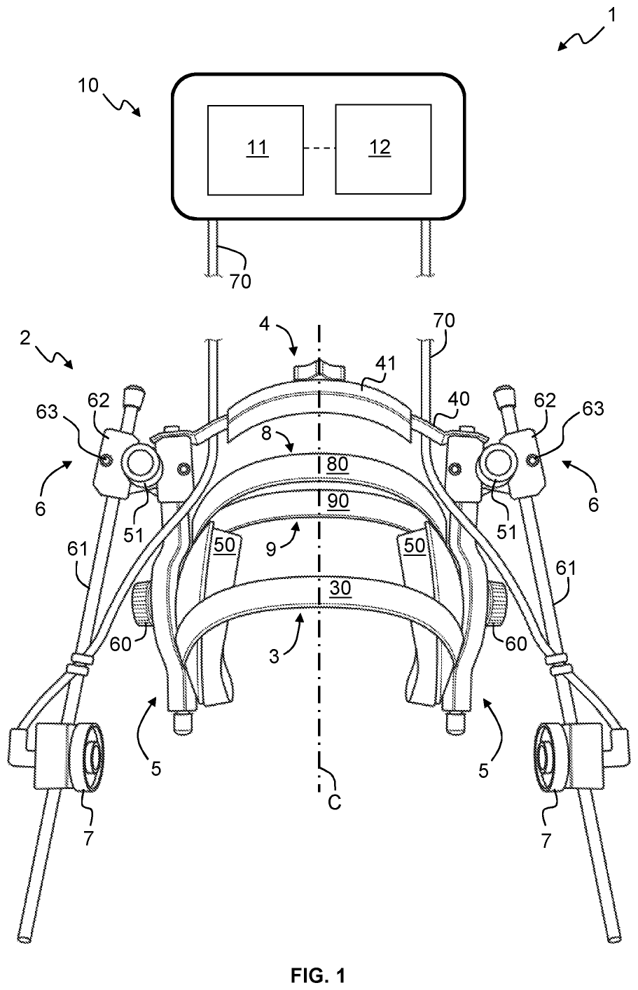

Referring now to FIG. 1, there is shown a head mounted image capture device 1 according to a first example for capturing facial motion of a user. The device 1 in this example includes a controller 10 and a helmet 2. The helmet 2 includes a front portion 3 for resting on the user's forehead, a back portion 4 for resting on the back of the user's head and a pair of side portions 5, each for resting on the sides of a user's head. Each side portion 5 includes an arm 6 to which a camera 7 is mounted.

The device 1 also includes a top portion 8 for resting on top of the user's head and neck portion 9 for resting on the back of the user's neck. Each of the front portion 3, top portion 8 and neck portion 9 are provided by straps 30, 80, 90 in this example, which are releasably connected to a respective side portion 5 at each of their ends to enable adjustment of their length in a conventional manner. Similarly, the back portion 4 in this example includes a semi-rigid plastic strap 40 with a rack and pinion mechanism 41 for adjusting its length.

Each side portion 5 includes a cushion 50, which is filled with foam in this example. Each arm 6 is pivotally adjustable relative to a respective one of the side portions 5, using an adjustment knob 60. Each arm also includes a rod 61 to which a respective camera 7 is adjustably mounted. In this example, the orientation of the camera 7 relative to the rod 61 is fixed, but it is able to slide along the length of the rod 61. However, it is envisaged that the orientation of the camera 7 may also be adjustable in other examples.

The rod 61 is releasably secured within a clamp 62, which is pivotally mounted to a respective side portion 5 by a pivotal connection 51. The clamp 62 includes a screw 63 used to releasably secure the rod 61 in any one of a plurality of positions along its length. The pivotal connection 51 allows adjustment of the orientation of the clamp 61 relative to the side portion 5, thereby enabling the cameras 7 to be moved toward or away from the user's face. However, the pivotal connection 51 has a predetermined tension to inhibit inadvertent adjustment of the orientation of the clamp 61.

As shown in FIG. 1, the cameras 7 oppose and face one another directly at a location intended to be substantially aligned with the cheeks and/or nose of a user (not shown) wearing the device 1. As such, these cameras 7 are positioned laterally of the user's face for capturing image data relating to a respective side of the user's face.

In this example, the cameras 7 are aimed directly at one another. In other words, each camera 7 is oriented such that its image plane is parallel to a central plane C segmenting the lateral sides of the device 1. However, it is envisaged that the cameras 7 may be oriented at an angle with respect to the central plane.

The controller 10 includes a memory 11 and a processor 12 operatively connected to the memory 11. Each camera 7 is connected to the controller 10 via a respective cable 70. The controller 10 is configured to receive image data from the camera 7 and to store it on the memory 11. The processor 12 is configured to reconstruct at least a portion of the user's face based on data acquired from the two cameras 7. More specifically, the processor 12 is configured to assemble or stitch together image data acquired from the two cameras 7, thereby to create a digital representation of the user's face.

Known head mounted image capture devices for capturing facial motion of a user normally use at least 3 cameras, and generally obstruct the view of the user. This invention mitigates this issue by using a pair of cameras 7 positioned laterally of the user's face, and reconstructing the user's face to generate a digital representation from only those two lateral cameras 7. The reconstruction is preferably performed using a neural network.

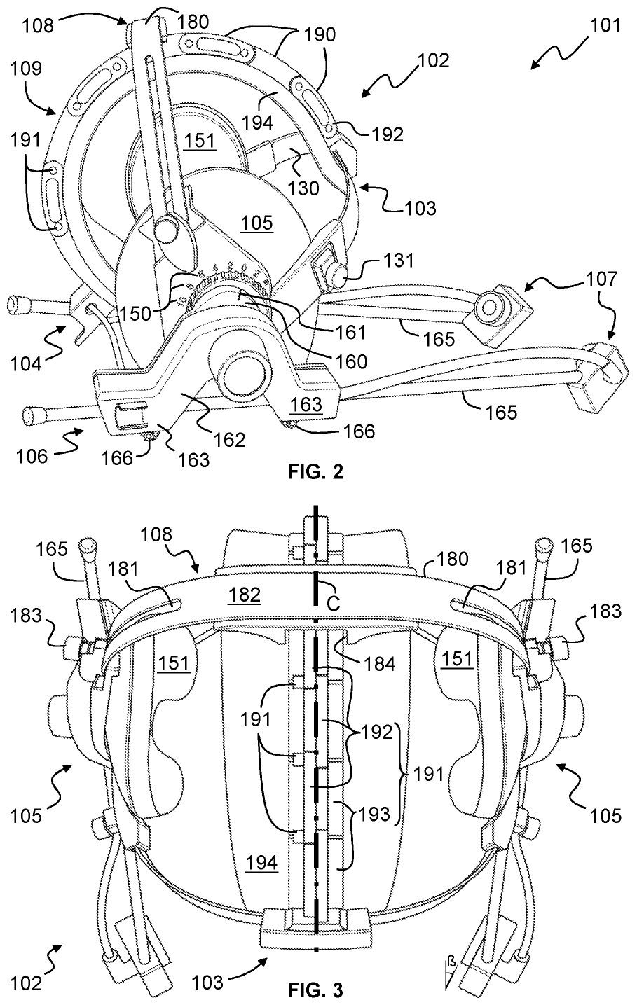

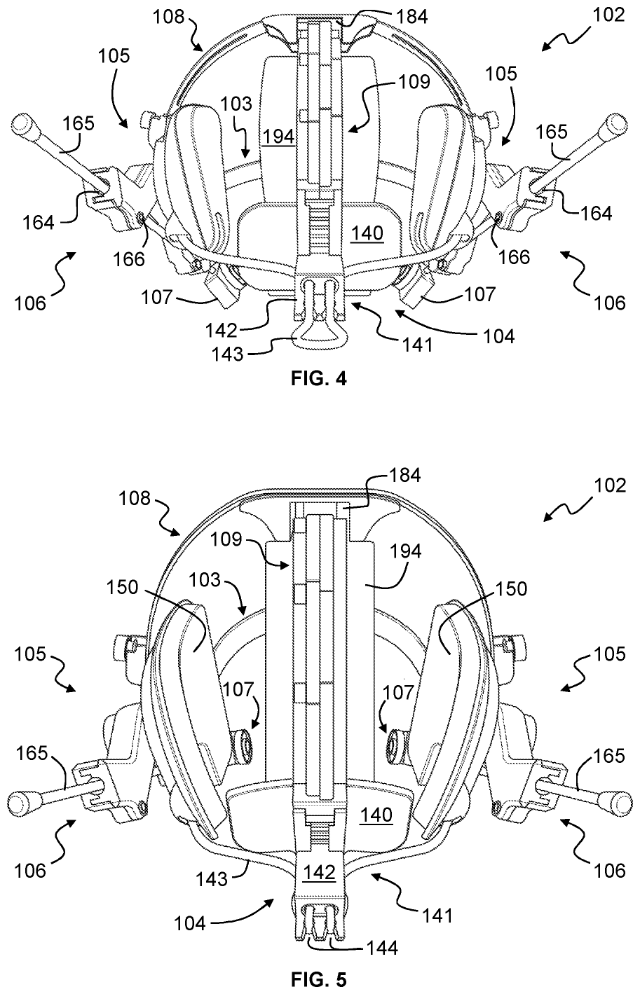

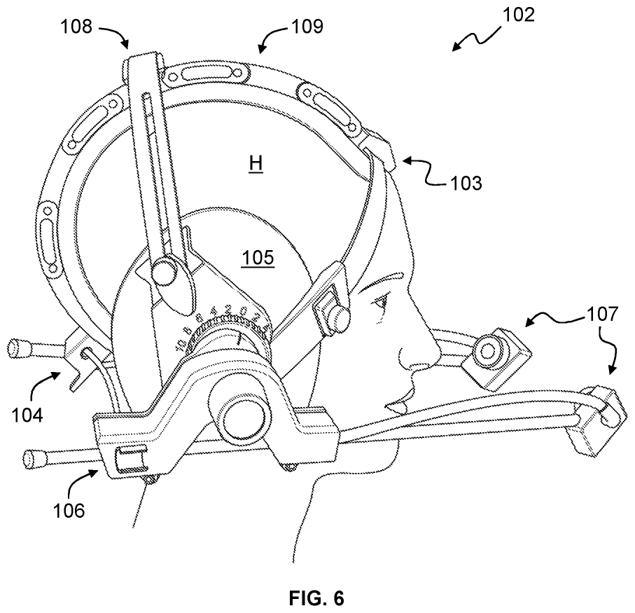

FIGS. 2 to 6 show a head mounted image capture device 101 according to a second example. The device 101 in this example includes a helmet 102 with a front portion 103 for resting on the user's forehead, a back portion 104 for resting on the back of the user's head and a pair of side portions 105, each for resting on the sides of a user's head. Each side portion 105 includes an arm 106 to which a camera 107 is mounted. The device 101 also includes a top portion 108 for resting on top of the user's head H and an articulated structure 109 connecting the front portion 103 to the back portion 104 for approximating the profile of the head of the user.

The front portion 103 in this example includes a semi-rigid plastic strap 130. Each end of the strap 130 is releasably secured to a respective one of the side portions 105 by a clamp 131 to enable adjustment of its length.

The back portion 104 includes a cushion support plate 140 and an adjustment mechanism 141 secured to the rear side of the cushion support plate 140. The adjustment mechanism 141 includes a locking member 142 that is step-wise adjustable toward and away from the articulated structure 109. The back portion 104 also includes an elasticated cord 143 attached at each end to a respective one of the side portions 105. The elasticated cord 143 also extends through a pair of holes in the locking member 142 to form a loop. The locking member 142 includes a pair of locking slots 144 having a necked portion for releasably retaining respective portions of the elasticated cord 143 to enable adjustment of its effective length.

Each side portion 105 includes a series of visual indicators 150, in the form of numbers in this example. Each arm 106 includes a hub 160 with a visual indicator 161, in the form of a line, that cooperates with the visual indicators 150 of the side portion 105 to which it is mounted, to provide an indication of the orientation of the arm 106. This facilitates the configuration of the helmet 102, and also enables the orientation of the arms 106 to be synchronised in a simple manner. Each side portion 105 also includes a cushion 151, which is filled with foam in this example.

Each arm 106 also includes a pair of legs 162 that diverge from one another at an oblique angle. The legs 162 have respective feet 163 that are coaxial with, but extend away from, one another. Each foot 163 includes a hole 164 extending along its length through which a rod 165 of the arm 106 extends. Each leg 162 is formed in two parts, which can be clamped or loosened by bolts 166 and together form a clamp to releasably secure the rod 165 in position.

One of the cameras 107 is mounted to the end of each rod 165 and faces inwardly, toward the other camera 107 but at an angle relative thereto. More particularly, each camera 107 is oriented such that its image plane is at an angle ß with respect to a central plane C segmenting the lateral sides of the device 101. In this example, the angle ß is approximately 15 degrees, but it is envisaged that the angle may be greater or less than this angle. For example, the angle may be 20 degrees, 30 degrees or even 45 degrees. Similarly, the angle may be 10 degrees, 5 degrees or zero degrees.

The top portion 108 includes a semi-rigid plastic strap 180 with a pair of slots 181, each of which extends from adjacent one of its ends and terminates at a central portion 182 of the strap 180. Each side of the strap 180 is releasably secured to a respective one of the side portions 105 by a threaded fastener 183 that extends through one of the slots 181 and releasably clamps the strap 180 into position to enable adjustment of its length. The top portion 108 also includes a locating slot 184 that receives and locates the articulated structure 109 relative to the top portion 108.

The articulated structure 109 includes a plurality of elements 190 pivotally connected together in series by fasteners 191, which enable the angular position of the elements 190 to be adjusted relative to one another. In this manner, the articulated structure 109 forms a kind of spine that extends along the central plane C of the helmet 102.

Each element 190 includes a short bar 192 with rounded ends, through which the fasteners 191 go, and a cushion support plate 193. A cushion 194 is provided, which extends along the articulated structure 109 from the front portion 103 to the back portion 104, for supporting the helmet 102 on the user's head. The cushion 194 is mounted at a first of its ends to the front portion 103 and at a second of its ends to the cushion support plate 140 of the back portion 104. The cushion 194 is also mounted to the cushion support plate 193 of each element 190 along its length. The cushion 194 is filled with foam in this example.

It will be appreciated by those skilled in the art that several variations to the aforementioned embodiments are envisaged without departing from the scope of the invention.

1. A head mounted image capture device for capturing facial motion of a user, the device comprising a helmet and a pair of opposed cameras, characterised in that each camera is positioned laterally of a user's face for capturing image data relating to a respective side of the user's face.

2. The device of claim 1 comprising a central plane segmenting the lateral sides of the device, wherein each camera is oriented such that the angle between its image plane and the central plane is less than 45 degrees.

3. The device of claim 2, wherein each camera is oriented such that the angle between its image plane and the central plane is less than 30 degrees.

4. The device of claim 3, wherein each camera is oriented such that the angle between its image plane and the central plane is less than 20 degrees.

5. The device of claim 1, wherein the or each camera is configured to be substantially aligned with the user's cheeks and/or nose.

6. The device of claim 1, comprising a memory and a processor operatively connected to the memory, wherein the processor is configured to reconstruct, in use, at least a portion of the user's face based on data acquired from both cameras using a neural network.

7. The device of claim 1, wherein the helmet comprises:
a front portion for resting on the user's forehead;
a back portion for resting on the back of the user's head; and
at least two side portions, each for resting on the sides of a user's head.

8. The device of claim 6, wherein the helmet comprises:
a front portion for resting on the user's forehead;
a back portion for resting on the back of the user's head; and
at least two side portions, each for resting on the sides of a user's head.

9. The device of claim 7, wherein the back portion comprises a strap or cord connected to each side portion and having an adjustable length.

10. The device of claim 7, comprising a top portion for resting on top of the user's head, wherein the top portion comprises a strap or cord connected to each side portion and having an adjustable length, each end of the strap or cord of the top portion being releasably secured to one of the side portions to enable adjustment of its length.

11. The device of claim 9, comprising a top portion for resting on top of the user's head, wherein the top portion comprises a strap or cord connected to each side portion and having an adjustable length, each end of the strap or cord of the top portion being releasably secured to one of the side portions to enable adjustment of its length.

12. The device of claim 7, wherein the front portion comprises a strap or cord connected to each side portion and having an adjustable length; each end of the strap or cord of the top portion being releasably secured to one of the side portions to enable adjustment of its length.

13. The device of claim 9, wherein the front portion comprises a strap or cord connected to each side portion and having an adjustable length; each end of the strap or cord of the top portion being releasably secured to one of the side portions to enable adjustment of its length.

14. The device of claim 11, wherein the front portion comprises a strap or cord connected to each side portion and having an adjustable length; each end of the strap or cord of the top portion being releasably secured to one of the side portions to enable adjustment of its length.

15. The device of claim 7, wherein each side portion comprises an arm to which one of the cameras is mounted.

16. The device of claim 14, wherein each side portion comprises an arm to which one of the cameras is mounted.

17. The device of claim 15, wherein each arm is rotatable relative to the side portion, each side portion and/or arm including at least one visual indicator for determining the orientation of the arm.

18. The device of claim 7, comprising an articulated structure connecting the front portion to the back portion for approximating the profile of the head of the user.

19. A computer-implemented method of reconstructing at least a portion of a user's face based on data acquired from at least one camera positioned laterally of the user's face, the method comprising reconstructing at least a front portion of the user's face using a neural network.

20. A method of assembling image data acquired from at least one camera positioned laterally of the user's face, the method comprising reconstructing at least a front portion of the user's face using a neural network.
